(19) United States
(12) Patent Application Publication
(10) Pub. No.: US 2019/0098013 A1
(43) Pub. Date: Mar. 28, 2019

(54) System and Methods for Location Verification with Blockchain Controls

(71) Applicant: Walmart Apollo, LLC, Bentonville, AR (US)

(72) Inventor: Bruce W. Wilkinson, Rogers, AR (US)

(21) Appl. No.: 16/140,016

(22) Filed: Sep. 24, 2018

Related U.S. Application Data
(60) Provisional application No. 62/562,622, filed on Sep. 25, 2017.

(51) Int. Cl. H04L 29/06; G06F 17/30; H04L 9/06; H04L 9/08; H04W 4/021

(52) U.S. Cl. CPC H04L 63/107; G06F 17/30283; G06F 17/30206; H04L 2209/38; H04L 9/0643; H04L 9/0825; H04W 4/021; G06F 17/30185

(57) ABSTRACT

Described in detail herein is a location verification system that includes a central computing system can generate a cryptographically verifiable ledger. The central computing system can receive first event information associated with an initiation of a transfer of one or more physical objects to a third party. In response to receiving the first event information the central computing system can generate in the cryptographically verifiable ledger additional block information associated with the first event information and a first hash. The central computing system can verify that the locations traveled by the mobile device correspond with a path embedded in the first hash and can generate a second additional block containing one or more transaction records associated with the second event information in response to the verification.

### CROSS-REFERENCE TO RELATED PATENT APPLICATION

This application claims priority to U.S. Provisional Application 62/562,622 filed on Sep. 25, 2017, the content of which is hereby incorporated by reference in its entirety.

### BACKGROUND

A blockchain may generally refer to a distributed database that maintains a growing and ordered list or chain of records in which each block contains a hash of some or all previous records in the chain to secure the record from tampering and unauthorized revision. The blockchain may be managed in a peer-to-peer network or by a private entity.

### BRIEF DESCRIPTION OF THE FIGURES

Illustrative embodiments are shown by way of example in the accompanying figures and should not be considered as a limitation of the present invention. The accompanying figures, which are incorporated in and constitute a part of this specification, illustrate one or more embodiments of the invention and, together with the description, help to explain the invention. In the figures:

FIG. 1 is a block diagram of an exemplary mobile device that can be utilized to implement and/or interact with embodiments of a location verification system;

FIG. 2 illustrates a path including multiple geo-fences in accordance with an exemplary embodiment;

FIG. 3 illustrates an exemplary network diagram of a location verification system in accordance with an exemplary embodiment;

FIG. 4 depicts blocks in a blockchain as configured in accordance with an exemplary embodiment;

FIG. 5 depicts blockchain transactions in accordance with an exemplary embodiment;

FIG. 6 is a flowchart depicting a sequence of steps performed in an exemplary embodiment;

FIG. 7 is a flowchart depicting a blockchain update in accordance with an exemplary embodiment;

FIG. 8 depicts an exemplary system in accordance with an exemplary embodiment;

FIG. 9 illustrates a block diagram an exemplary computing device in accordance with an exemplary embodiment;

FIG. 10 depicts an exemplary sequence of steps performed by a location verification system using blockchain controls to verify a route during delivery using location coordinates in an exemplary embodiment;

FIG. 11 depicts another exemplary sequence of steps performed by a location verification system using blockchain controls to verify a route during delivery using geo-fences in an exemplary embodiment; and

FIG. 12 is a flowchart illustrating the process of a time based verification system using blockchain controls to verify an elapsed time for delivery in an exemplary embodiment.

### DETAILED DESCRIPTION

Described in detail herein is a location verification system with blockchain controls. In one embodiment, a central computing system generates a cryptographically verifiable ledger and receives first event information associated with an initiation of a transfer of one or more physical objects to a third party. In response to receiving the first event information the central computing system generates, in the cryptographically verifiable ledger, first additional block information associated with the first event information that includes multiple location coordinates and a first hash. The central computing system can verify that the locations traveled by the mobile device correspond with a path between the location coordinates embedded in the first hash. The central computing system can then generate a second additional block containing one or more transaction records associated with the second event information in response to the verification.

In one embodiment, the location verification system includes a mobile device equipped with a processor and a location-based sensor. The system further includes a central computing system in communication with the mobile device. The central computing system is configured to generate a cryptographically verifiable ledger represented by a sequence of data blocks. Each data block contains one or more transaction records and each subsequent data block contains a hash value associated with a previous data block. The central computing system is further configured to receive first event information associated with an initiation of a transfer of one or more physical objects to a third party. The first event information includes a destination location associated with the third party. The central computing system is further configured to generate a path from an origin location to the destination location associated with the third party, embed a plurality of location coordinates associated with different locations on the path into a first hash, and generate in the cryptographically verifiable ledger, in response to receiving the first event information, at least a first additional block containing one or more new transaction records associated with the first event information and the first hash. The central computing system is also configured to track locations traveled by the mobile device by receiving location data from the location-based sensor and to receive second event information from the mobile device. The second event information is associated with a completion of the transfer of one or more physical objects to the third party. Additionally the central computing system is configured to verify that the locations traveled by the mobile device correspond with the path embedded in the first hash by verifying that the locations traveled by the mobile device correspond with the location coordinates associated with different locations on the path embedded in the first hash, and to generate at least a second additional block containing one or more transaction records associated with the second event information in response to the verifying.

In an embodiment, a location verification method includes generating, via a central computing system in communication with a mobile device, a cryptographically verifiable ledger represented by a sequence of data blocks. Each data block contains one or more transaction records and each subsequent data block contains a hash value associated with a previous data block. The mobile device is equipped with a processor and a location-based sensor. The method further includes receiving, via the central computing system, first event information associated with an initiation of a transfer of one or more physical objects to a third party. The first event information includes a destination location associated with the third party. The method further includes generating, with the central computing system, a path from an origin location to the destination location associated with the third party, and embedding, with the central computing system, location coordinates associated with different locations on the path into a first hash. The method also includes generating in the cryptographically verifiable ledger, via the central computing system, in response to receiving the first event information, at least a first additional block containing one or more new transaction records associated with the first event information and the first hash. The method further includes tracking, via the central computing system, locations traveled by the mobile device by receiving location data from the location-based sensor and second event information from the mobile device, the second event information associated with a completion of the transfer of one or more physical objects to the third party. The method additionally verifies, via the central computing system, that the locations traveled by the mobile device correspond with the path embedded in the first hash by verifying that the locations traveled by the mobile device correspond with the location coordinates associated with different locations on the path embedded in the first hash, and generating at least a second additional block containing one or more transaction records associated with the second event information in response to the verifying.

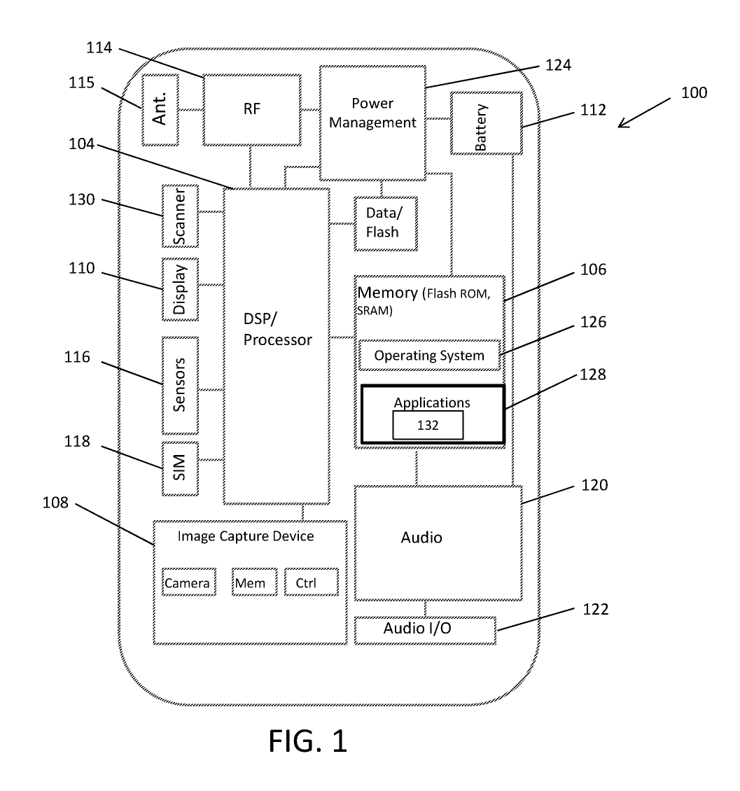

FIG. 1 is a block diagram of a mobile device that can be utilized to implement and/or interact with embodiments of a location verification system in an exemplary embodiment. The mobile device 100 can be a smartphone, tablet, subnotebook, laptop, personal digital assistant (PDA), handheld device, such as a Symbol® MC18 and/or any other suitable mobile device that can be programmed and/or configured to implement and/or interact with embodiments of the system via wireless communication. For example, the mobile device 100 can be a Symbol® MC18. Symbol® MC18 can be a handheld mobile computer configured to execute the Android and/or Windows operating system. The Symbol® MC18 can include 1D and 2D Scanner, Wi-Fi (802.11a/b/g/n), Camera, VGA Display, Android 2.3 and/or Windows 7, 1 GB RAM/8 GB Flash, Standard Battery.

The mobile device 100 can include a processing device 104, such as a digital signal processor (DSP) or microprocessor, memory/storage 106 in the form a non-transitory computer-readable medium, an image capture device 108, a touch-sensitive display 110, a power source 112, a radio frequency transceiver 114 and a reader 130. Some embodiments of the mobile device 100 can also include other common components commonly, such as sensors 116, subscriber identity module (SIM) card 118, audio input/output components 120 and 122 (including e.g., one or more microphones and one or more speakers), and power management circuitry 124. The sensors 116 can include a location-based sensor 134, configured to determine the location of the mobile device 100.

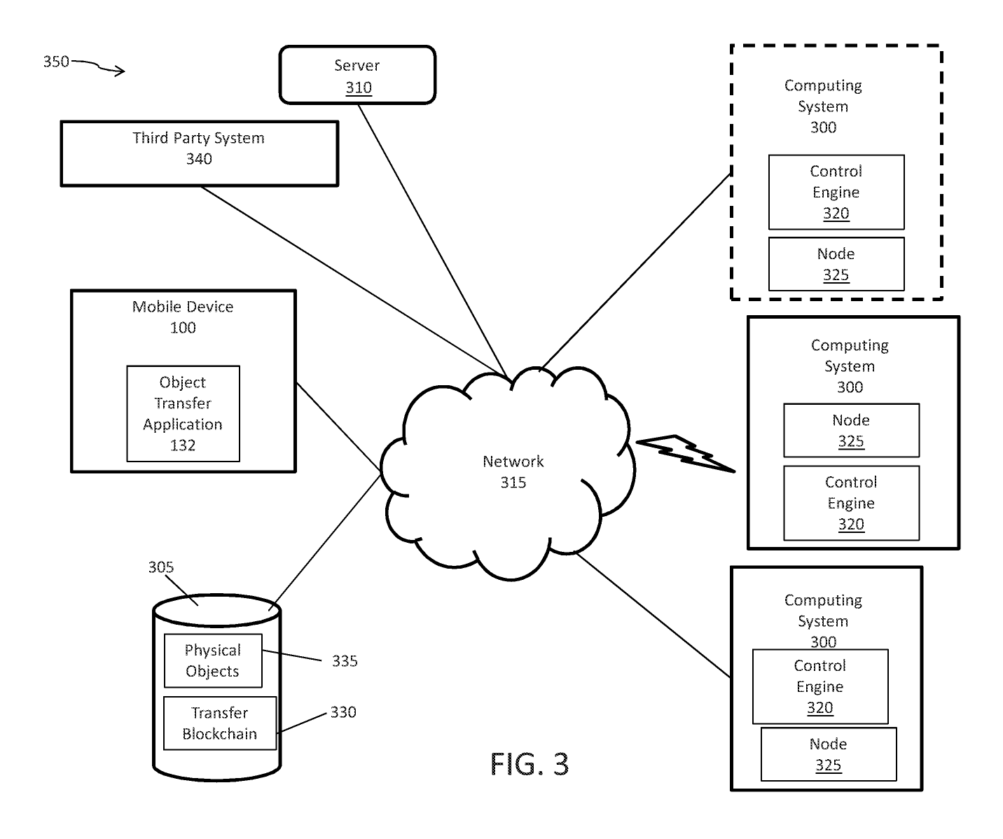

The memory 106 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 126 and applications 128 can be embodied as computer-readable/executable program code stored on the non-transitory computer-readable memory 106 and implemented using any suitable, high or low level computing language and/or platform, such as, e.g., Java, C, C++, C#, assembly code, machine readable language, and the like. In some embodiments, the applications 128 can include a facility application configured to interact with the microphone, a web browser application, a mobile application specifically coded to interface with one or more servers of embodiments of the system for data transfer in a distributed environment. One or more servers are described in further detail with respect to FIG. 3. While memory is depicted as a single component those skilled in the art will recognize that the memory can be formed from multiple components and that separate non-volatile and volatile memory devices can be used.

The processing device 104 can include any suitable single- or multiple-core microprocessor of any suitable architecture that is capable of implementing and/or facilitating an operation of the mobile device 100. For example, a user can use the mobile device 100 in a facility to perform an image capture operation, capture a voice input of the user (e.g., via the microphone), transmit messages including a captured image and/or a voice input and receive messages from a central computing system, display data/information including GUIs of the user interface 110, captured images, voice input transcribed as text, and the like. The mobile device 100 can perform the aforementioned operations using on an internet browser executing on the mobile device, or any web-based application. The processing device 104 can be programmed and/or configured to execute the operating system 126 and applications 128 to implement one or more processes and/or perform one or more operations. The processing device 104 can retrieve information/data from and store information/data to the storage device 106.

The RF transceiver 114 can be configured to transmit and/or receive wireless transmissions via an antenna 115. For example, the RF transceiver 114 can be configured to transmit data/information, such as input based on user interaction with the mobile device 100. The RF transceiver 114 can be configured to transmit and/or receive data/information having at a specified frequency and/or according to a specified sequence and/or packet arrangement.

The touch-sensitive display 110 can render user interfaces, such as graphical user interfaces to a user and in some embodiments can provide a mechanism that allows the user to interact with the GUIs. For example, a user may interact with the mobile device 100 through touch-sensitive display 110, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 112 can be implemented as a battery or capacitive elements configured to store an electric charge and power the mobile device 100. In exemplary embodiments, the power source 112 can be a rechargeable power source, such as a battery or one or more capacitive elements configured to be recharged via a connection to an external power supply. The scanner 130 can be implemented as an optical reader configured to scan and decode machine-readable elements disposed on objects.

In one embodiment, the mobile device can execute an object transfer application 132. The object transfer application 132 can be an executable configured to track the location of the mobile device 100. The object transfer application 132 can store the coordinates traveled by the mobile device in response to executing the object transfer application 132 at an origin. The mobile device 100 can store the coordinates after a specified time interval. The mobile device 100 can transmit all the stored coordinates to a central computing system in response to closing the session of the object transfer application 132 and/or in response to the location based sensor detecting a specified location. Alternatively, the mobile device 100 cans transmit the location coordinates to the central computing system when storing or at some other pre-determined interval or event. The session of the object transfer application 132 can be closed upon reaching a destination. In one embodiment, the central computing system can control the operation of the object transfer application 132. The central computing system can execute the object transfer application 132 and close the session of the object transfer application 132. For example, the central computing system can detect that the mobile device 100 has reached a destination, based on the location of the mobile device 100, and close out the session of the object transfer application 132. The central computing system is described herein with respect to FIG. 3.

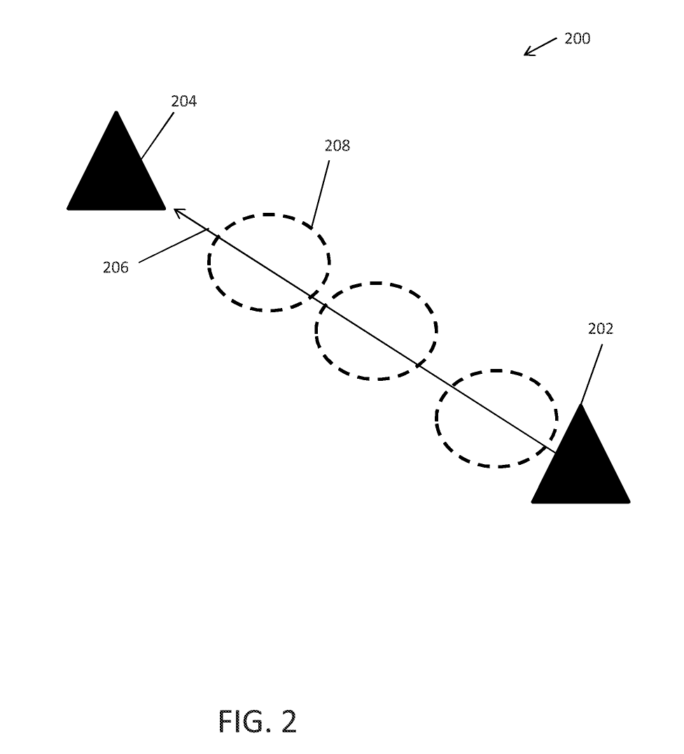

FIG. 2 illustrates a path including multiple geo-fences in accordance with an exemplary embodiment. In one embodiment, a central computing system can determine a path 200 from an original location 202 to a destination location 204 as indicated by the arrow 206. The central computing system can determine multiple geo-fences 208 along the path 200. The geo-fences 208 can be of a specified radius and can be made up of specified coordinates. Each geo-fence can be the same or different radius of another geo-fence along the same path 200. The central computing system can determine the geo fences 208 by calculating range of locations based on a specified radius and the coordinates of the origin location 202 and the destination location 204. The central computing system is discussed in further detail with respect to FIG. 3.

FIG. 3 illustrates an exemplary network diagram of a location verification system in accordance with an exemplary embodiment. The location verification system 350 can include one or more data storage devices 305, one or more central computing systems 300, one or more mobile devices 100, and one or more third party systems 340. The central computing system 300 can be in communication with the data storage devices 305, the mobile device 100, and the third party systems 340 via a communications network 315. The mobile device 100 can be associated with a user responsible for delivering one or more physical objects to a third party and can execute an object transfer application 132. The central computing system 400 can execute at least one instance of a control engine 320. The control engine 420 can be an executable application executed on the central computing system 300. The control engine 320 can execute the process of the location verification system 350 as described herein. The central computing system 300 can include one or more nodes 325. Each of the one or more nodes 325 can store a copy of a blockchain record and/or a shared ledger associated with the transfer of one or more physical objects. The one or more nodes 325 can be configured to update the blocks in the blockchain record based on the operation of transfer of one or more physical objects.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The central computing system 300 includes one or more computers or processors configured to communicate with the data storage devices 305, the mobile devices 100 and third party systems 340. The data storage devices 305 can store information/data, as described herein. For example, the data storage devices 305 can include a physical objects database 335 and a transfer blockchain 330. The physical objects database 435 can include information associated with physical objects and a representation of physical objects. The transfer blockchain 330 can be embodied as a blockchain storage system that is configured to store a blockchain record or a shared ledger based on a transfer of physical objects to a third party. For example, the blockchain storage system can store digital licenses, invoices, receipts, or rights of ownership associated with physical objects and the central computing system 300 can use the blocks of the blockchain to authorize the transfer of ownership of physical objects. The data storage devices 305 and the central computing system 300 can be located at one or more geographically distributed locations from each other. Alternatively, the data storage devices 305 can be included within the central computing system 300.

In exemplary embodiments, the central computing system 300 can receive an event. The event can include information associated with initiation of a transfer of one or more physical objects to a third party. The event can also include identifiers associated with the one or more physical objects and a destination location, associated with the third party, for the delivery of the one or more physical objects. The central computing system 300 can execute the control engine 320 in response to receiving the event. The control engine 320 can query the physical objects database 330 to retrieve information associated with the one or more physical objects using the identifiers.

The control engine 320 can generate a path from an origin location to the destination location. The origin location can be a location of the one or more physical objects and/or a specified location. The control engine 320 can determine GPS coordinates for the origin location, one or more interim locations and the destination location. The control engine 320 can generate a hash key embedded with the GPS coordinates for the origin location and the destination location.

In one embodiment, the control engine 320 can calculate and identify multiple geo-fences along the path. Each of the geo-fences can be made up of GPS coordinates encompassing a specified radius. Each geo-fence can be of a same or different radius. The control engine 320 can generate a hash key embedded with the GPS coordinates encompassing each of the geo-fences, along with the GPS coordinates of the origin and destination location.

The information associated with the event can be stored in the transfer blockchain database 330 using the blockchain storage system. For example, the node 325 can generate a block in the transfer blockchain database 330. The block can store the information associated with the event along with the generated hash key. As noted above, the information can include information associated with ownership of the one or more physical objects. A private and public key can also be associated with the block storing the information associated with the event. Each of the blocks can include a public key and a private key. A user can grant access to another user by providing the public and private key to the block storing the information associated with the event. The other user can attempt to access the information associated with the event using the public and private key of the block. The node 325 can verify the public and private key of the block and provide access to the information associated with the event in response to verification.

The control engine 320 can transfer an alert to the mobile device 100 to initiate the transfer of the one or more physical objects. As noted above, the mobile device 100 can execute an object transfer application 132. The mobile device 100 can receive the alert with the object transfer application 132. In response to receiving the alert the location based sensor 134 in the mobile device 100 can start tracking and storing GPS coordinates traveled by the mobile device. In some embodiments, the object transfer application 132 may not be executing on the mobile device 100, and in response to receiving the alert, the mobile device 100 can automatically launch the object transfer application 132.

As noted above, the mobile device 100 can be associated with a user responsible for delivery of the one or more physical objects to the third party. The user can travel from the origin location to the destination location with the one or more physical objects and the mobile device 100. The object transfer application 132 can track and record, via the location based sensor 134, the GPS coordinates traveled by the mobile device 100. The object transfer application 132 can transmit an alert (i.e. another event) to the central computing system 300 in response to reaching the destination location. The event can include information associated with the completion of the transfer of one or more physical goods. In some embodiments, the object transfer application 132 can automatically transmit the alert to the central computing system in response to the location based sensor 134 determining the mobile device 100 is at the destination location. The alert can include the GPS coordinates traveled by the mobile device 100 along the route between origin and destination.

In one embodiment, the control engine 320 can verify the mobile device 100 traveled the generated path by comparing the received GPS coordinates traveled by the mobile device 100 with the GPS coordinates of the geo-fences embedded in the hash key stored in the block including information associated with the event and the hash key. The control engine 320 can verify the transfer of the one or more physical objects, by verifying that the mobile device 100 has traveled the generated path from the origin location to the destination location and stayed within the specified radii of geo-fences along the path.

In response to verifying the transfer of the one or more physical objects, the node 335 can generate a subsequent block including transaction records of transferring the one or more physical objects to the third party. Each new block created that is associated with transferring the one or more physical objects can include a hash key associated with the previous block. The hash key can include the GPS coordinates traveled by the mobile device 100. This can be referred to as a chain. For example, each time the one or more physical objects are transferred a block may be generated including transaction records associated the transfer of the physical objects. The new block can include a hash key of the block containing a digital license file. The control engine 320 can transmit the public and private key of the block including the information associated the event to provide access to a third party system 340 of the third party, in response to verifying the transfer of the one or more physical objects.

In one embodiment, “side chains” can also be created. For example, in the event that the control engine 320 is unable to verify the mobile device 100 traveled the generated path a new block can be generated including transaction records of a failure to transfer the one or more physical objects to the third party. For example, this may occur by comparing the received GPS coordinates traveled by the mobile device 100 with the GPS coordinates of the geo-fences embedded in the hash key stored in the block including information associated with the event and the hash key. The control engine 320 can transmit an alert to the third party system 340. The newly generated block may not include a hash key of the block including information associated with the event. Accordingly, the block containing the information associated with the event can be linked in two different chains.

In one embodiment, in addition to verifying a route or as a separate procedure, the transfer of the one or more physical objects can be verified based on the duration of time between delivery of the of the one or more physical objects. For example, in response to receiving the event associated with the initiation of transfer of the one or more physical objects, control engine 320 can generate a hash key embedded with a timestamp indicating a time the event was received. The node 325 can generate a block in the transfer blockchain database 330. The block can store the information associated with the event along with the generated hash key embedded with the timestamp. The object transfer application 132 can transmit an alert to the central computing system 300 in response to reaching the destination location. The alert can include a time of arrival at the destination location. The control engine 320 can verify the transfer of the one or more physical objects in response to determining the duration between the time of arrival at the destination location and the timestamp embedded in the hash is within a specified time period. As noted above, in response to verifying the transfer of the one or more physical objects, the node 335 can generate a subsequent block including transaction records of transferring the one or more physical objects to the third party.

In one embodiment, in addition to or separately from the embodiments previously discussed, the transfer of the one or more physical objects can be verified based on a hash key received from the third party system 340. For example, in response to the central computing system 300 receiving an alert to from the object transfer application 132 when the mobile device 132 reaches the destination location, the control engine 320 can generate a new hash key. The new hash key can be different than the hash key stored in the block including the information associated with the event. The new hash key can be configured to be paired with the hash key stored in the block including the information associated with the event. The control engine 320 can transmit the new hash key to the third party system 340.

The third party system 340 can transmit the new hash key to the mobile device 100. The object transfer application 132 can transmit the new hash key to the central computing system 300. The control engine 320 may attempt to pair the new hash key with the hash key stored in the block with the information associated with the event. In response to successfully pairing the new hash key with the hash key stored in the block with the information associated with the event, the control engine 320 can verify the transfer of the one or physical objects.

As a non-limiting example, the location verification system 350 can be implemented as in a retail store and/or e-commerce website. For example, the central computing system 300 can receive an event associated with the request to deliver products from a retail store to a third party. The third party can be a customer, charity organization, vendor and/or supplier. The products can be perishable items.

In one example, in response to the central computing system 300 receiving a request for delivery of perishable items, the control engine 350 can query the physical objects database 335 to determine an expiration date and time of the perishable items. The control engine 350 can generate a hash key embedded with a timestamp associated with the expiration date and time of the perishable items. The node 325 can generate a block in the transfer blockchain database 330. The block can store the information associated with the event along with the generated hash key. The block can store the information associated with the event along with the generated hash key embedded with the timestamp. The object transfer application 132 can transmit an alert to the central computing system 300 in response to reaching the destination location. The alert can include a time of arrival at the destination location. The control engine 320 can verify the transfer of the one or more physical objects in response to determining the duration between the time of arrival at the destination location and the timestamp embedded in the hash is within a specified time period. As noted above, in response to verifying the transfer of the one or more physical objects, the node 335 can generate a subsequent block including transaction records of delivery of the perishable items to the third party.

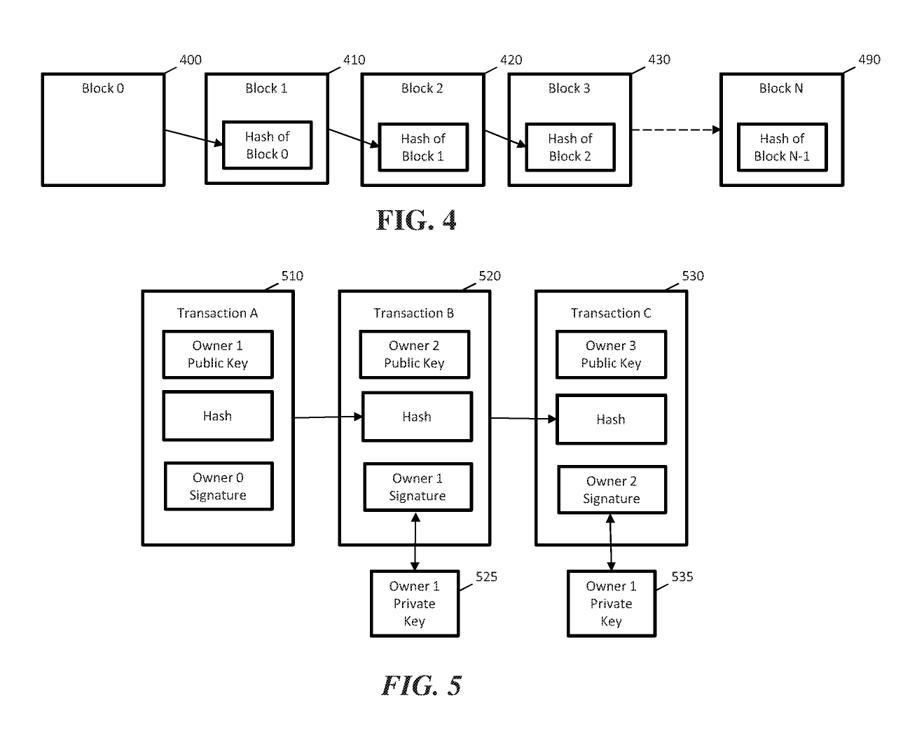

Descriptions of some embodiments of blockchain technology are provided with reference to FIGS. 4-8 herein. In some embodiments, blockchain technology may be utilized to verify the transfer of physical objects as described herein. One or more of the central computing systems described herein may include a node in a distributed blockchain system storing a copy of the blockchain record. Updates to the blockchain may include information associated with requests for transferring one or more physical objects, and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of being kept at a trusted party. However, exemplary embodiments of the present disclosure can also utilize a private (trusted) system to maintain the blockchains. A blockchain may generally refer to a distributed database that maintains a growing and ordered list or chain of records in which each block contains a hash of some or all previous records in the chain to secure the record from tampering and unauthorized revision. A hash generally refers to a derivation of original data. In some embodiments, the hash in a block of a blockchain may include a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may include one or more of a data hash of the previous block, a timestamp, a cryptographic nonce, a proof standard, and a data descriptor to support the security and/or incentive features of the system.

In some embodiments, the location verification system includes a distributed timestamp server including multiple nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, e.g., resulting from in-field authentication of autonomous electronic devices, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it.

Now referring to FIG. 4, an illustration of a blockchain according to embodiments of the present disclosure is shown. As mentioned in above, with reference to FIG. 3, a blockchain includes a hash chain or a hash tree in which each block added in the chain contains a hash of the previous block. In FIG. 4, block 0 400 represents a genesis block of the chain and can be generated in response to initiation of a request to transfer one or more physical objects. The block 0 400 can include information associated with the transfer of the one or more physical objects and a hash key embedded with one or more of GPS coordinates of the origin location, destination location, a path from the origin location and destination location, geo-fences along the path from the origin location and destination location, GPS coordinates encompassing each of the geo-fences, and a timestamp. The information associated with the transfer of the one or more physical objects can include information associated with the physical objects and information associated with the ownership of the one or more physical objects. Block 1 410 can be generated in response to a verification of the transfer of the one or more physical objects. The block 1 410 can contain a hash of block 0 400. If the transfer of one or more physical objects is verified the block 1 410 can include the information associated with the transfer of the one or more physical objects. Otherwise, the block 1 410 can include information indicating a transfer was not verified. Additional blocks can be generated as additional requests are received and each block that is generated can include a hash of a previous block. For example, block 2 420 can be generated in response to a subsequent request and can contain a hash of block 1 410, block 3 430 can be generated in response to a yet another subsequent request and can contain a hash of block 2 420, and so forth. Continuing down the chain, block N contains a hash of block N−1. In some embodiments, the hash may include the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may include a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may include a plurality of transaction and/or activity records.

In some embodiments, the blocks generated by the central computing system can contain rules and data for authorizing different types of actions and/or parties who can take action as described herein. In some embodiments, transaction and block forming rules may be part of the software algorithm on each node. When a new block is being formed, any node on the system can use the prior records in the blockchain to verify whether the requested action is authorized. For example, a block may contain a public key associated with the user of a user device that purchased/acquired the design file that allows the user to show possession and/or transfer the digital license using a private key. Nodes may verify that the user is in possession of the one or more physical objects and/or is authorized to transfer the one or more physical objects based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. Nodes can compete to provide proof-of-work to form a new block, and the first successful node of a new block earns a reward.

Now referring to FIG. 5, an illustration of blockchain based transactions according to some embodiments is shown. In some embodiments, the blockchain illustrated in FIG. 5 includes a hash chain protected by private/public key encryption. Transaction A 510 represents a transaction recorded in a block of a blockchain showing that owner 1 (recipient) (e.g., a first user of the first user device acquired the physical objects from owner 0). Transaction A 510 contains owner's 1 public key and owner 0's signature for the transaction and a hash of a previous block. When owner 1 (e.g., the first user of the first user device who purchased and/or acquired the design) transfers the design file to owner 2 (e.g., a second user of a second user device), a block containing transaction B 520 is formed. The record of transaction B 520 includes the public key of owner 2 (recipient), a hash of the previous block, and owner 1's signature for the transaction that is signed with the owner 1's private key 525 and verified using owner 1's public key in transaction A 510. If owner 2 (e.g., the second user) transfers the asset to owner 3 (the third user), a block containing transaction C 530 is formed. The record of transaction C 530 includes the public key of owner 3 (recipient), a hash of the previous block, and owner 2's signature for the transaction that is signed by owner 2's private key 535 and verified using owner 2's public key from transaction B 620. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may include any type of rules that regulate who and how the chain may be extended. In some embodiments, the rules in a blockchain may include clauses of a smart contract that is enforced by the peer-to-peer network.

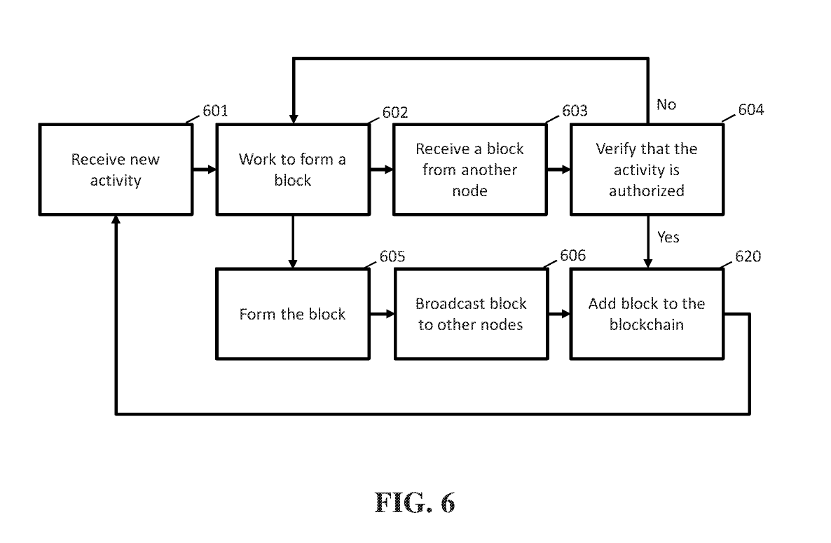

Now referring to FIG. 6, a flow diagram according to some embodiments is shown. In some embodiments, the steps shown in FIG. 6 may be performed by a computer system as described in FIG. 3, a server, a distributed server, a timestamp server, a blockchain node, and the like. In some embodiments, the steps in FIG. 6 may be performed by one or more of the nodes in a system using blockchain for record keeping.

In step 601, a node receives a new activity in response to a request for transfer of one or more physical objects. The new activity may include an update to the record being kept in the form of a blockchain. In some embodiments, for blockchain supported digital or physical record keeping, the new activity can correspond to the ownership of the one or more physical objects and/or the transfer of the ownership of the physical objects from a first user device to a second user device. In some embodiments, the new activity may be broadcasted to a plurality of nodes on the network prior to step 601. In step 602, the node works to form a block to update the blockchain. In some embodiments, a block may include a plurality of activities or updates and a hash of one or more previous block in the blockchain. In some embodiments, the system may include consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In step 620, the node then adds the block to its copy of the blockchain. In the event that the node receives a block formed by another node in step 603 prior to being able to form the block, the node works to verify that the activity (e.g., authentication of transfer) recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these blocks if they pass verification. When a subsequent block is received from another node, the node may then use the subsequent block to determine which of the received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

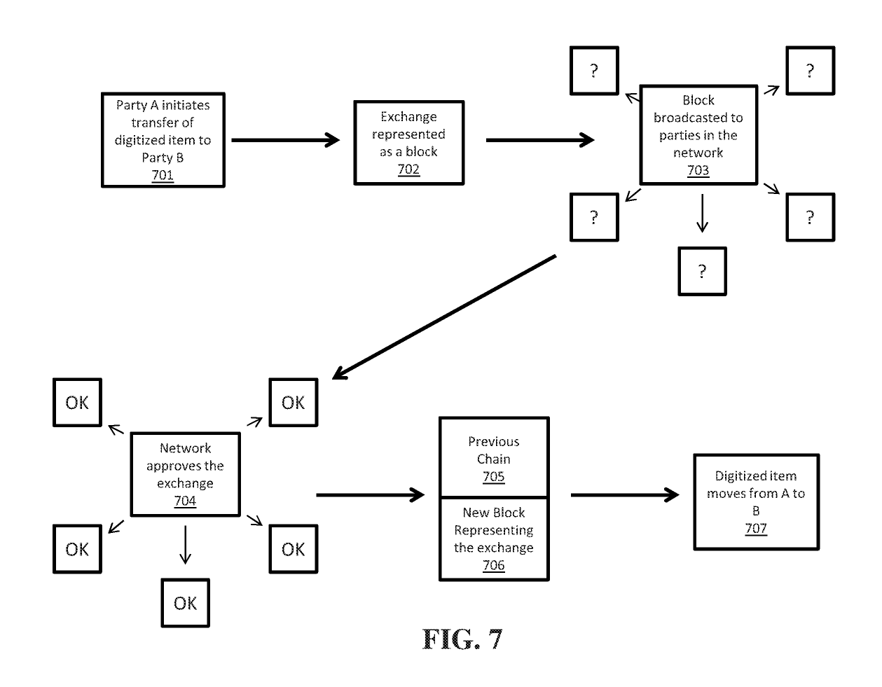

Now referring to FIG. 7, a process diagram for a blockchain update according to some embodiments is shown. In step 701, party A (the first user device) initiates the delivery and transfer one or more physical objects to party B (the second user device). In some embodiments, Party A may be authenticated by signing the transaction with a private key that may be verified with a public key in the previous transaction associated with the physical objects are to be transferred. In step 702, the authentication initiated in step 701 is represented as a block. In some embodiments, the transaction may be compared with transaction records in the longest chain in the distributed system to verify part A's authentication. In some embodiments, a plurality of nodes in the network may compete to form the block containing the authentication record. In some embodiments, nodes may be required to satisfy proof-of-work by solving a difficult mathematical problem to form the block. In some embodiments, other methods of proof such as proof-of-stake, proof-of-space, etc. may be used in the system. In step 703, the block is broadcasted to parties in the network. In step 704, nodes in the network authenticate party A by examining the block that contains the party A's authentication. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the object to be transferred). In some embodiments, a block may be approved with consensus of the nodes in the network. After a block is approved, the new block 706 representing the authentication is added to the existing chain 705 including blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the physical objects can be transferred from party A to party B (e.g., from the first mobile autonomous electronic device to the second autonomous electronic device).

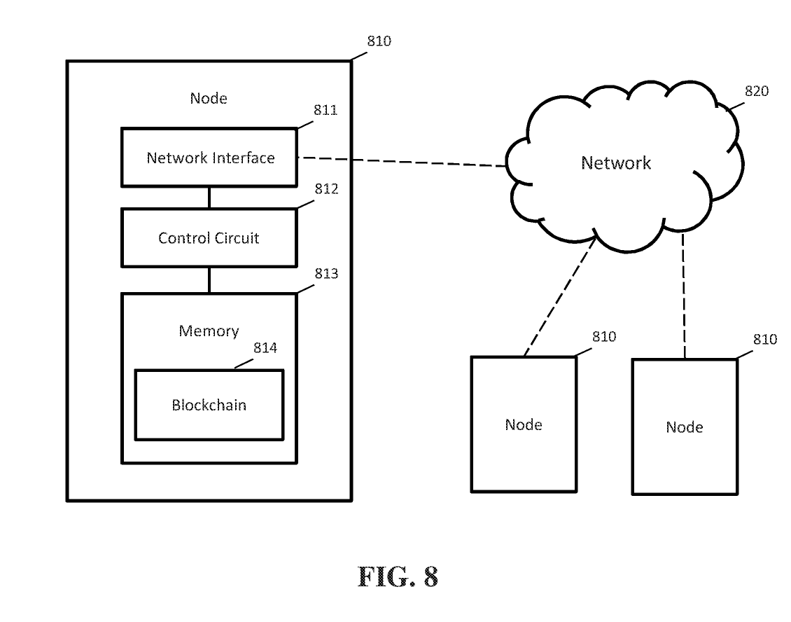

Now referring to FIG. 8, a system according to some embodiments is shown. A location verification system includes a plurality of nodes 810 communicating over a network 820. In some embodiments, the nodes 810 may include a distributed blockchain server and/or a distributed timestamp server. Each node 810 in the system includes a network interface 811, a control circuit 812, and a memory 813.

The control circuit 812 may include a processor, a microprocessor, and the like and may be configured to execute computer readable instructions stored on a computer readable storage memory 813. The computer readable storage memory may include volatile and/or non-volatile memory and have stored upon it a set of computer readable instructions which, when executed by the control circuit 812, causes the node 810 update the blockchain 814 stored in the memory 813 based on communications with other nodes 810 over the network 820. In some embodiments, the control circuit 812 may further be configured to extend the blockchain 814 by processing updates to form new blocks for the blockchain 814. Generally, each node may store a version of the blockchain 814, and together, may form a distributed database. In some embodiments, each node 810 may be configured to perform one or more steps described with reference to FIGS. 6-8 herein.

The network interface 811 may include one or more network devices configured to allow the control circuit to receive and transmit information via the network 820. In some embodiments, the network interface 811 may include one or more of a network adapter, a modem, a router, a data port, a transceiver, and the like. The network 820 may include a communication network configured to allow one or more nodes 810 to exchange data. In some embodiments, the network 820 may include one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

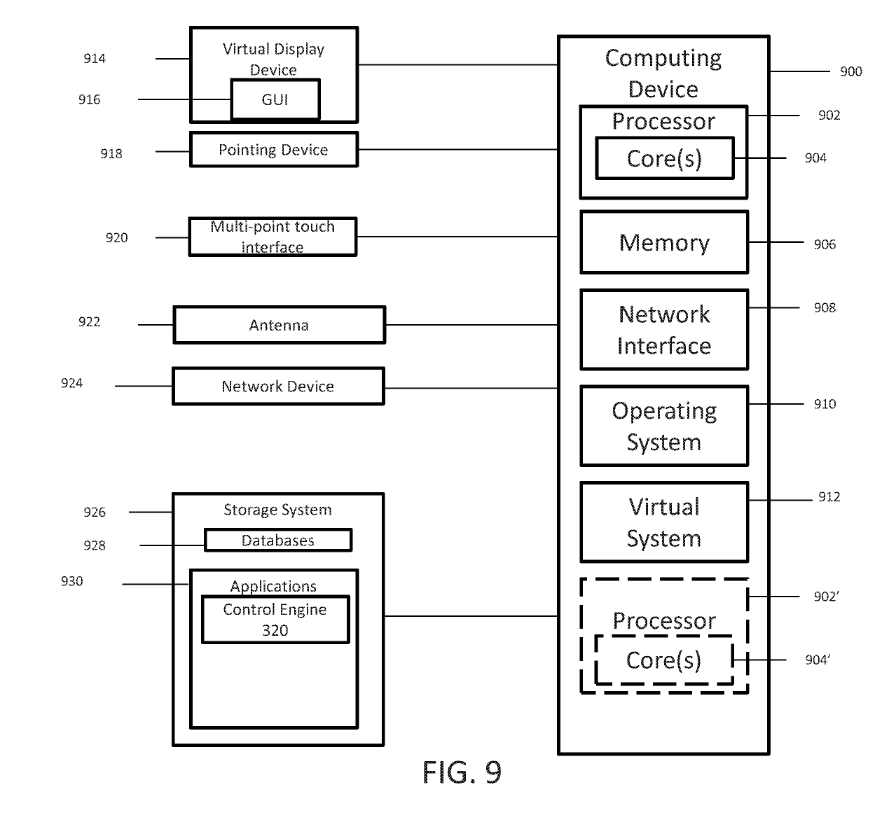

FIG. 9 is a block diagram of an example computing device for implementing exemplary embodiments of the present disclosure. Embodiments of the computing device 900 can implement embodiments of the location verification system. For example, the computing device can be embodied as a portion of the central computing system and/or third party system. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the control engine 320) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments of the present disclosure. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual machine 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof. The computing device 900 can receive data from input/output devices such as, an image capturing device 934. The image capturing device 934 can capture still or moving images. A user may interact with the computing device 900 through a visual display device 914, such as a computer monitor, which may display one or more graphical user interfaces 916, multi touch interface 920 and a pointing device 918.

The computing device 900 may also include one or more storage devices 926, such as a hard-drive, CD-ROM, or other computer readable media, for storing data and computer-readable instructions and/or software that implement exemplary embodiments of the present disclosure (e.g., applications such as the control engine 320). For example, exemplary storage device 926 can include one or more databases 928 for storing information associated with ownership of physical objects and information associated the physical objects. The databases 928 may be updated manually or automatically at any suitable time to add, delete, and/or update one or more data items in the databases.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the central computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run any operating system 910, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 900 and performing the operations described herein. In exemplary embodiments, the operating system 910 may be run in native mode or emulated mode. In an exemplary embodiment, the operating system 910 may be run on one or more cloud machine instances.

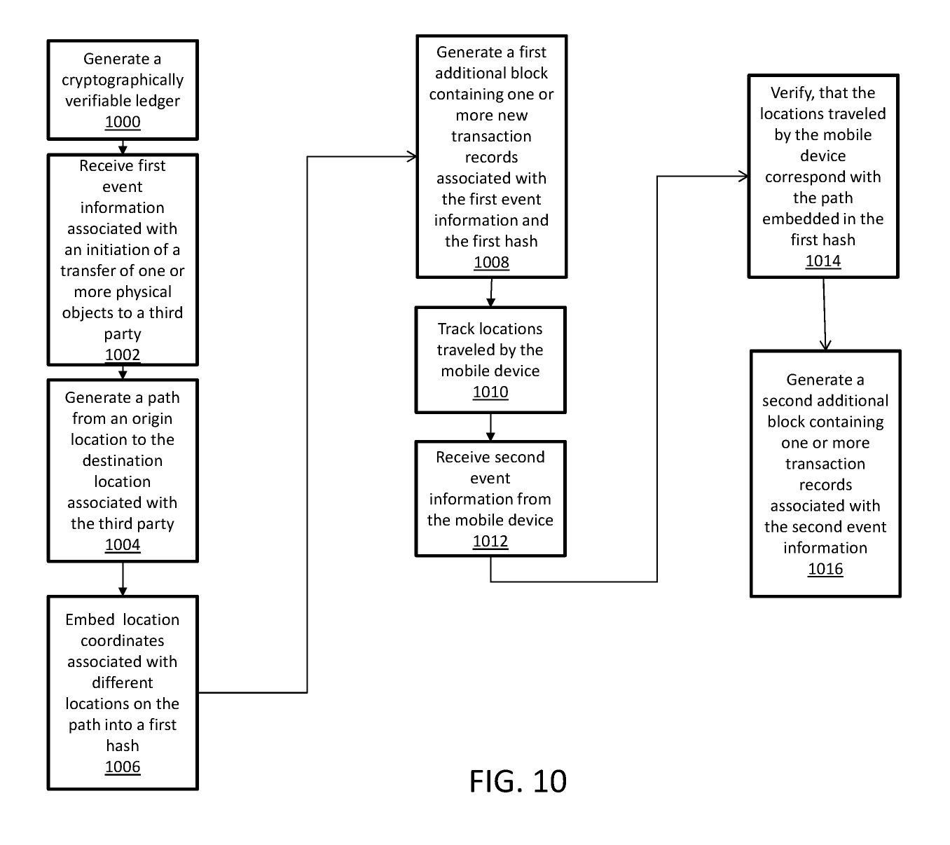

FIG. 10 is a flowchart illustrating the process of the location verification system using blockchain controls. In operation 1000, a central computing system (e.g. central computing system 300 as shown in FIG. 3) can generate a cryptographically verifiable ledger (e.g. transfer blockchain 330 as shown in FIG. 3) represented by a sequence of data blocks, each data block containing one or more transaction records and each subsequent data block containing a hash value associated with a previous data block. The central computing system can be in communication with a mobile device (e.g. mobile device 100 as shown in FIGS. 1 and 3). The mobile device can include a processor (e.g. processor 104 as shown in FIG. 1) and a location-based sensor (e.g. location based sensor 134 as shown in FIG. 1).

In operation 1002, the central computing system can receive first event information associated with an initiation of a transfer of one or more physical objects to a third party. The first event information includes a destination location (e.g. destination location 204 as shown in FIG. 2) associated with the third party. In operation 1004, the central computing system can generate a path (e.g. a path 200 as shown in FIG. 2) from an origin location (e.g. origin location 202 as shown in FIG. 2) to the destination location associated with the third party. In operation 1006, the central computing system can embed location coordinates associated with different locations on the path into a first hash. In operation 1008, in response to receiving the first event information the central computing system can generate a first additional block containing one or more new transaction records associated with the first event information and the first hash, in the cryptographically verifiable ledger.

In operation 1010, the central computing system can track locations traveled by the mobile device by receiving location data from the location-based sensor. In operation 1012, the central computing system can receive second event information from the mobile device. The second event information can be associated with a completion of the transfer of one or more physical objects to the third party. In operation 1014, the central computing system can verify, that the locations traveled by the mobile device correspond with the path embedded in the first hash by verifying that the locations traveled by the mobile device correspond with the plurality of location coordinates associated with different locations on the path embedded in the first hash. In operation 1016, the central computing system can generate a second additional block containing one or more transaction records associated with the second event information in response to the verification.

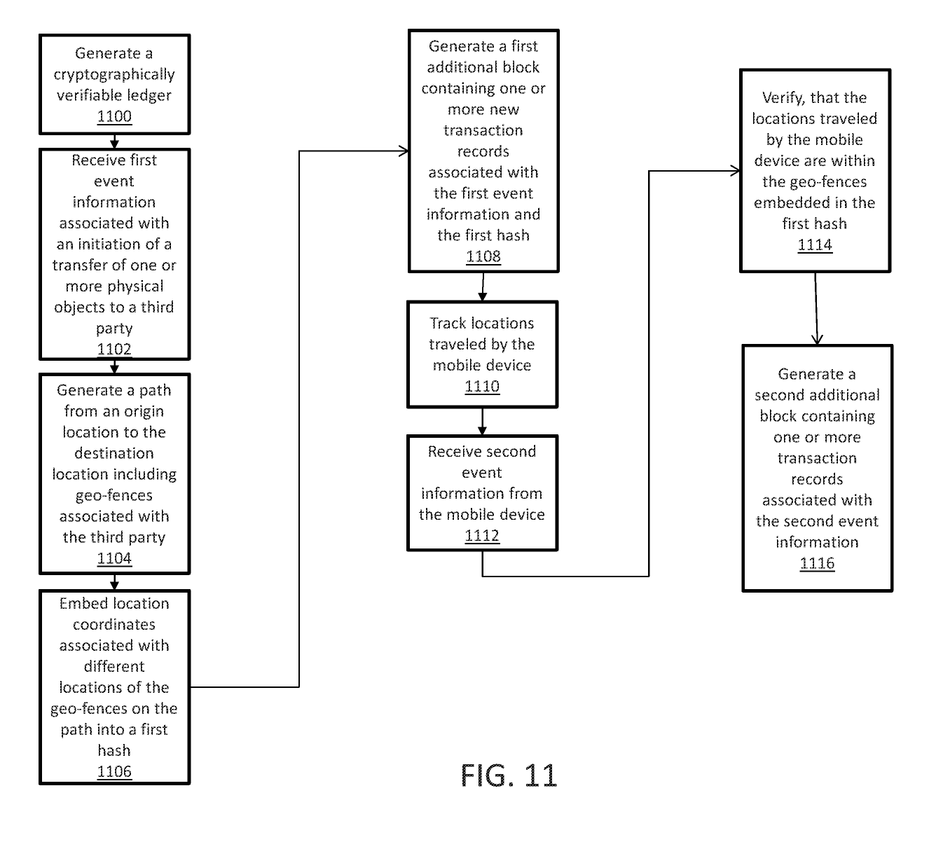

FIG. 11 is a flowchart illustrating the process of the location verification system using blockchain controls. In operation 1100, a central computing system (e.g. central computing system 300 as shown in FIG. 3) can generate a cryptographically verifiable ledger (e.g. transfer blockchain 330 as shown in FIG. 3) represented by a sequence of data blocks, each data block containing one or more transaction records and each subsequent data block containing a hash value associated with a previous data block. The central computing system can be in communication with a mobile device (e.g. mobile device 100 as shown in FIGS. 1 and 3). The mobile device can include a processor (e.g. processor 104 as shown in FIG. 1) and a location-based sensor (e.g. location based sensor 134 as shown in FIG. 1).

In operation 1102, the central computing system can receive first event information associated with an initiation of a transfer of one or more physical objects to a third party. The first event information includes a destination location (e.g. destination location 204 as shown in FIG. 2) associated with the third party. In operation 1104, the central computing system can generate a path (e.g. a path 200 as shown in FIG. 2) from an origin location (e.g. origin location 202 as shown in FIG. 2) to the destination location associated with the third party including geo-fences of a specified radius along the path. In operation 1106, the central computing system can embed location coordinates associated with different locations on the path, including each of the geo-fences, into a first hash. In operation 1108, in response to receiving the first event information the central computing system can generate a first additional block containing one or more new transaction records associated with the first event information and the first hash, in the cryptographically verifiable ledger.

In operation 1110, the central computing system can track locations traveled by the mobile device by receiving location data from the location-based sensor. In operation 1112, the central computing system can receive second event information from the mobile device. The second event information can be associated with a completion of the transfer of one or more physical objects to the third party. In operation 1114, the central computing system can verify, that the locations traveled by the mobile device that the locations traveled by the mobile device are within the radius of each of the plurality of geo-fences based on the different locations on the path embedded in the first hash. In operation 1116, the central computing system can generate a second additional block containing one or more transaction records associated with the second event information in response to the verification.

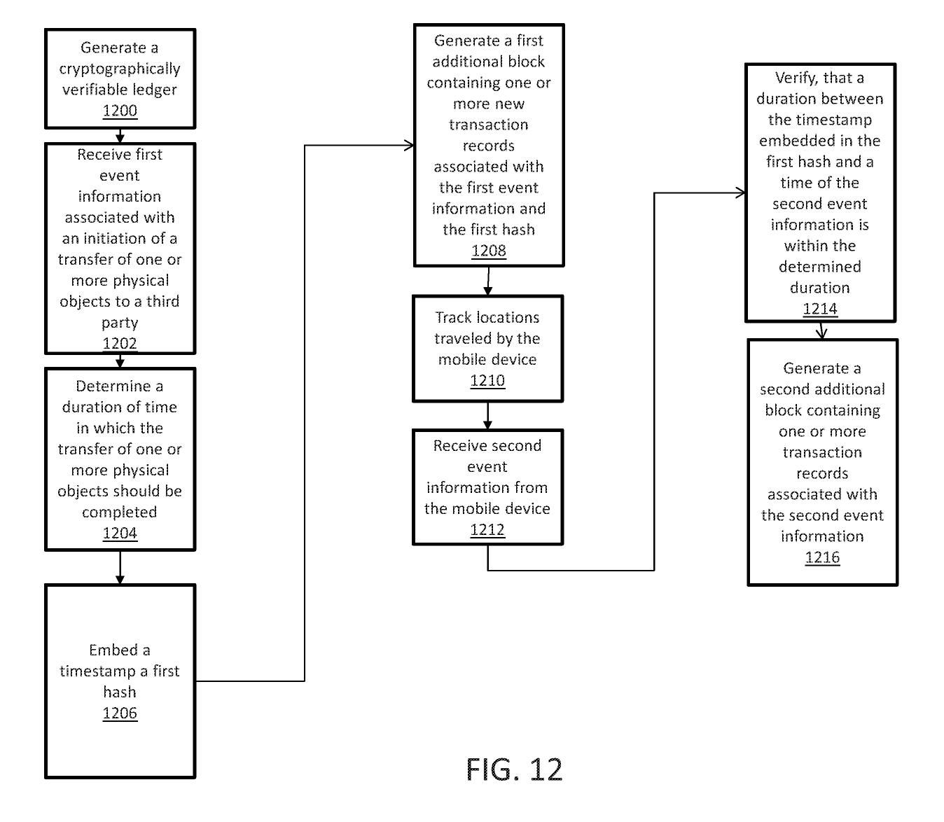

FIG. 12 is a flowchart illustrating the process of a time based verification system using blockchain controls. In operation 1200, a central computing system (e.g. central computing system 300 as shown in FIG. 3) can generate a cryptographically verifiable ledger (e.g. transfer blockchain 330 as shown in FIG. 3) represented by a sequence of data blocks, each data block containing one or more transaction records and each subsequent data block containing a hash value associated with a previous data block. The central computing system can be in communication with a mobile device (e.g. mobile device 100 as shown in FIGS. 1 and 3). The mobile device can include a processor (e.g. processor 104 as shown in FIG. 1) and a location-based sensor (e.g. location based sensor 134 as shown in FIG. 1).

In operation 1202, the central computing system can receive first event information associated with an initiation of a transfer of one or more physical objects to a third party. The first event information includes a destination location (e.g. destination location 204 as shown in FIG. 2) associated with the third party. In operation 1204, the central computing system can determine duration of time in which the transfer of one or more physical objects should be completed. In operation 1206, the central computing system can embed a time stamp in the first hash. In operation 1208, in response to receiving the first event information the central computing system can generate a first additional block containing one or more new transaction records associated with the first event information and the first hash, in the cryptographically verifiable ledger.

In operation 1210, the central computing system can receive second event information from the mobile device. The second event information can be associated with a completion of the transfer of one or more physical objects to the third party. In operation 1212, the central computing system can track a time at which the second event was received from the mobile device. In operation 1214, the central computing system can verify, that a duration between the timestamp embedded in the first hash and a time of the second event information is within the determined duration. In operation 1216, the central computing system can generate a second additional block containing one or more transaction records associated with the second event information in response to the verification.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A location based verification system, the system comprising:
a mobile device equipped with a processor and a location-based sensor; and
a central computing system in communication with the mobile device, the central computing system configured to:
generate a cryptographically verifiable ledger represented by a sequence of data blocks, each data block containing one or more transaction records and each subsequent data block containing a hash value associated with a previous data block;
receive first event information associated with an initiation of a transfer of one or more physical objects to a third party, wherein the first event information includes a destination location associated with the third party;
generate a path from an origin location to the destination location associated with the third party;
embed a plurality of location coordinates associated with different locations on the path into a first hash;
generate, in response to receiving the first event information, at least a first additional block containing one or more new transaction records associated with the first event information and the first hash, in the cryptographically verifiable ledger;
track locations traveled by the mobile device by receiving location data from the location-based sensor;
receive second event information from the mobile device, the second event information associated with a completion of the transfer of one or more physical objects to the third party;
verify that the locations traveled by the mobile device correspond with the path embedded in the first hash by verifying that the locations traveled by the mobile device correspond with the plurality of location coordinates associated with different locations on the path embedded in the first hash, and
generate at least a second additional block containing one or more transaction records associated with the second event information in response to the verifying.

2. The system of claim 1, wherein the path includes a plurality of geo-fences of a specified radius.

3. The system of claim 2, wherein the central computing system is configured to verify that the locations traveled by the mobile device are within the radius of each of the plurality of geo-fences.

4. The system of claim 1, wherein the central computing system is configured to embed a timestamp in the first hash.

5. The system of claim 4, wherein the central computing system is configured to generate the at least second additional block containing the one or more transaction records associated with the second event information in response to also verifying that a duration between the timestamp embedded in the first hash and a time of the second event information is within a specified time period.

6. The system of claim 5, wherein the one or more physical objects are perishable goods.

7. The system of claim 6, wherein the central computing system is configured to determine the specified time period based on an expiration date of the perishable goods.

8. The system of claim 1, wherein the central computing system generates a second hash and transmits the second hash to a system associated with the third party.

9. The system of claim 8, wherein the system associated with the third party transmits the second hash to the mobile device.

10. The system of claim 9, wherein the central computing system is configured to generate the at least second additional block containing the one or more transaction records associated with the second event information following a verification of the second hash received by the mobile device.

11. A location based verification method, the method comprising:
generating, via a central computing system in communication with a mobile device, a cryptographically verifiable ledger represented by a sequence of data blocks, each data block containing one or more transaction records and each subsequent data block containing a hash value associated with a previous data block, the mobile device equipped with a processor and a location-based sensor;
receiving, via the central computing system, first event information associated with an initiation of a transfer of one or more physical objects to a third party, wherein the first event information includes a destination location associated with the third party;
generating, via the central computing system, a path from an origin location to the destination location associated with the third party;
embedding, via the central computing system, a plurality of location coordinates associated with different locations on the path into a first hash;
generating, via the central computing system, in response to receiving the first event information, at least a first additional block containing one or more new transaction records associated with the first event information and the first hash, in the cryptographically verifiable ledger;
tracking, via the central computing system, locations traveled by the mobile device by receiving location data from the location-based sensor;
receiving, via the central computing system, second event information from the mobile device, the second event information associated with a completion of the transfer of one or more physical objects to the third party;
verifying, via the central computing system, that the locations traveled by the mobile device correspond with the path embedded in the first hash by verifying that the locations traveled by the mobile device correspond with the plurality of location coordinates associated with different locations on the path embedded in the first hash, and
generating, via the central computing system, at least a second additional block containing one or more transaction records associated with the second event information in response to the verifying.

12. The method of claim 11, wherein the path includes a plurality of geo-fences of a specified radius.

13. The method of claim 12, further comprising verifying, via the central computing system, that the locations traveled by the mobile device are within the radius of each of the plurality of geo-fences.

14. The method of claim 11, further comprising embedding, via the central computing system, a timestamp in the first hash.

15. The method of claim 14, further comprising generating, via the central computing system, the at least second additional block containing the one or more transaction records associated with the second event information in response to also verifying that a duration between the timestamp embedded in the first hash and a time of the second event information is within a specified time period.

16. The method of claim 15, wherein the one or more physical objects are perishable goods.

17. The method of claim 16, further comprising determining, via the central computing system, the specified time period based on an expiration date of the perishable goods.

18. The method of claim 11, further comprising generating, via the central computing system, a second hash and transmits the second hash to a system associated with the third party.

19. The method of claim 18, wherein the system associated with the third party transmits the second hash to the mobile device.

20. The method of claim 19, further comprising generating, via the central computing system, the at least second additional block containing the one or more transaction records associated with the second event information following a verification of the second hash received by the mobile device.
